(19) United States
(12) Patent Application Publication
(10) Pub. No.: US 2015/0193482 A1
(43) Pub. Date: Jul. 9, 2015

(54) Topic sentiment identification and analysis

(71) Applicant: 30dB, Inc., Nederland, CO (US)

(72) Inventors: Howard Kaushansky, Nederland, CO (US); Kirill Kireyev, Berkeley, CA (US); Bradley John Perry, Breckenridge, CO (US)

(73) Assignee: 30dB, Inc., Nederland, CO (US)

(21) Appl. No.: 14/589,348

(22) Filed: Jan. 5, 2015

Related U.S. Application Data
(60) Provisional application No. 61/924,427, filed on Jan. 7, 2014.

(51) Int. Cl. G06F 17/30

(52) U.S. Cl. CPC G06F 17/30312

(57) ABSTRACT

Information containing peoples' opinion from unstructured sources on a variety of topics of interest is collected and analyzed. These unstructured sources include but are not limited to social media information on the Internet. The collected data is cleansed and sent to an analysis system to determine, among other things, the topics of discussion (including multi-word topics of discussion), the co-occurring topics of discussion for each topic of discussion identified and the sentiment for each. Once determined the analyzed data is delivered to a storage and indexing system from which several application can retrieve and provide this information to users.

### RELATED APPLICATION

The present application relates to and claims the benefit of priority to U.S. Provisional Patent Application No. 61/924,427 filed Jan. 7, 2014, which is hereby incorporated by reference in its entirety for all purposes as if fully set forth herein.

### BACKGROUND OF THE INVENTION

1. Field of the Invention

Embodiments of the present invention relate, in general, to data analysis and more particularly, to identifying and correlating opinionated information from various media sources.

2. Relevant Background

For many years, there have been various vehicles for people to express their opinions on the Internet. The recent growth of social media (e.g. Facebook, Twitter, blogs, etc.) and reviews have provided a rich environment for people to view others' opinions on the vast array of topics discussed online. To date, consumers assessing the aggregate opinion of Internet users, or groups of Internet users, has been largely limited to structured data. This includes, for example, product reviews and public polls. While reviews and polling data provide a valuable source of public opinion data, they represent a different and much smaller corpus of opinion information than can be derived from a broad analysis of unstructured posts in social media.

Search has been the traditional method by which people online discover information of interest. As new forms of information have become available, many search engines have expanded their capabilities to provide a search function to access this information. For example, current search engines provide search functionality focused on blogs, images, maps, and shopping. A search functionality focused on shopping does provide aggregate favorability scores from structured reviews on certain products. However, a search capability that provides an assessment of public opinion from a plurality of sources of opinion information, including unstructured free text from social media over a wide variety of discussion topics would provide a different and potentially more valuable assessment of public opinion information.

Analysis of unstructured opinion data from social media provides a much different view of public opinion from reviews and other forms of structured data for a number of reasons. These include, without limitation: (1) social media presents much more of a conversational, “listening in” form of opinion information; (2) people who post reviews represent a small subset of the population of people who have purchased a product or viewed a form of entertainment and taken the additional step of writing a review versus social media where a larger portion of the population may express an opinion on the same product or entertainment; (3) reviews and other structured data do not provide the same scope of coverage as analysis of unstructured opinions, which includes, without limitation, opinions on public issues, political candidates, media, and current events which reviews do not; (4) there is a growing concern that due to the smaller incidence of participants of reviews and other forms of structured information, they may be subject to fraud to skew results and deceive those reviewing such information; and, (5) reviews tend to be very positive. Bazaarvoice, a company providing the infrastructure to enable companies to allow their consumers to post reviews, reports that the average rating in the consumer packaged goods category is 4.12 out of 5 stars and that eighty percent of consumer packaged goods reviews are 4 stars or above.

Unstructured opinion information found in social media provides a more comprehensive scope of subjects on which the public expresses opinion, includes a broader portion of the population, and, due to the higher number of opinions expressed, provides an environment less susceptible to fraud and deception.

Research has shown that consumers are interested in opinion data. According to one research service poll, 92% of consumers read product reviews when considering a purchase. Another service reports that 89% of people find online information channels trustworthy for product and service reviews. Notwithstanding the potential challenges that reviews provide as referenced above, social media provides a different corpus of opinion information, not just on the products, services, and entertainment for which there may be reviews, but also on every subject of discussion online, many of which are not addressed by reviews or polls. Analysis of social media also provides a time element that may not be available in reviews and/or polls. For example, assessing immediate public opinion on a court decision, a political announcement, or a celebrity disclosure cannot be accomplished quickly or effectively by reviews or polls. Providing the analysis of social media to consumers gives consumers the ability to view opinion information on more subjects, from a different corpus of information, and in a more timely manner.

Additional advantages and novel features of this invention shall be set forth in part in the description that follows, and in part will become apparent to those skilled in the art upon examination of the following specification or may be learned by the practice of the present invention. The advantages of the present invention may be realized and attained by means of the instrumentalities, combinations, compositions, and methods particularly pointed out in the appended claims.

### SUMMARY OF THE PRESENT INVENTION

One or more embodiments of the present invention collects and analyzes information from various unstructured sources online containing people's opinions on a variety of topics of discussion. These sources include, but are not limited to, social media information. The collected data is cleansed and sent to an analysis system to determine, among other things, the topics of discussion, the co-occurring topics of discussion for each topic of discussion identified, and the sentiment for each. Once determined, the analyzed data is delivered to a storage and indexing system from which several applications can retrieve and provide this information to users.

While there are many applications that can utilize analyzed information of this type, the initial identified applications include (1) opinion search, (2) embedding search results into other writings and locations on the web to enable viewers to view and modify opinion search results, (3) browser plug-ins to enable users to view opinion data on words, phrases, images, and other information viewed online, (4) mobile applications to search and view opinion information from a mobile phone or other mobile device, and, (5) providing opinion information to support the inclusion of public opinion in link based, display, and other forms of advertising.

One embodiment of the present invention is directed to a computer-implemented method for analysis of accessible data. The method comprises performing, by at least one processor, steps that begin with identifying a plurality of topics of interest wherein each topic of interest is characterized by a plurality of words. With topics identified, content is detected from accessible data by matching each topic of interest within text of the accessible data. The process continues by analyzing accessible data for words indicating a sentiment, and in response to the detected content, includes words that indicate sentiment, and determine whether the sentiment is positive or negative. The results of this analysis are then entered into an indexing and storage media wherein each topic of interest and the sentiment form a corpus of sentiment data.

Another embodiment of the present invention is directed to an analysis of accessible data. The system includes at least one processor, a storage medium, and at least one program stored in the storage medium that is executable by at least one processor. The program(s) is comprised of instructions to identify a plurality of topics of interests wherein each topic of interest is characterized by a plurality of words. Then, to detect content from accessible data by matching each topic of interest within text of the accessible data. Then, to analyze accessible data for words indicating a sentiment, and then, in response to the detected content including words indicating sentiment, determine whether the sentiment is positive or negative. Thereafter, additional instructions direct the processor to enter the results into an indexing and a storage media, wherein each topic of interest and the sentiment form a corpus of sentiment data.

In other embodiments of the present invention, these program instructions, that are executable on a processor, can be stored on non-transitory computer readable storage medium.

Other features of the present invention include features such as identifying the topics of interest by a preexisting topic of interest list, by analysis of residual text, or by manually entering each topic of interest. The process described herein can also include determining whether detected content includes one or more co-occurring topics of interest, wherein a co-occurring topic of interest is an additional topic of interest within a predefined proximity of each topic of interest, forming a relationship between each topic of interest and the co-occurring topic of interest. In some instances, the co-occurring topic of interest is a multi-word topic of interest.

In another aspect of the present invention, matching, as introduced above, includes using a decreasing word matching process whereby matching first occurs for an entirety of the plurality of words of each topic of interest. Thereafter, it decreases the plurality of words of each topic of interest by one word until each topic of interest is a single word. And, in response to the detected content including words indicating sentiment, a sentiment value can be associated with each topic of interest.

Initiating a runtime query to ascertain the sentiment associated with a specific topic of interest over a period of time can access data stored on the storage media. The runtime query aggregates sentiment values in the corpus of sentiment data for the specific topic of interest over the period of time and provides a list of co-occurring topics of interest.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the present invention itself will be best understood, by reference to the following description of one or more embodiments taken in conjunction with the accompanying drawings, wherein:

FIG. 1 provides an overall functional analysis and design of the steps involved in analyzing opinionated social media, according to one embodiment of the present invention;

FIG. 2 provides a detailed system diagram expanding on the functional steps provided in FIG. 1, according to one embodiment of the present invention;

FIG. 3A provides a high level depiction of association between a topic of interest and single word co-occurring topics, according to one embodiment of the present invention;

FIG. 3 B provides a high level depiction of association between a topic of interest and multi-word co-occurring topics of interest, according to one embodiment of the present invention;

FIG. 4 provides a high level block diagram of the features available and process flow for entering a query and retrieving analyzed opinion data, according to one embodiment of the present invention;

FIG. 5 shows opinion information as a result of entering a query to one embodiment of the data analysis system of the present invention; and

FIG. 6 presents one embodiment of an exemplary computer system for implementing the present invention.

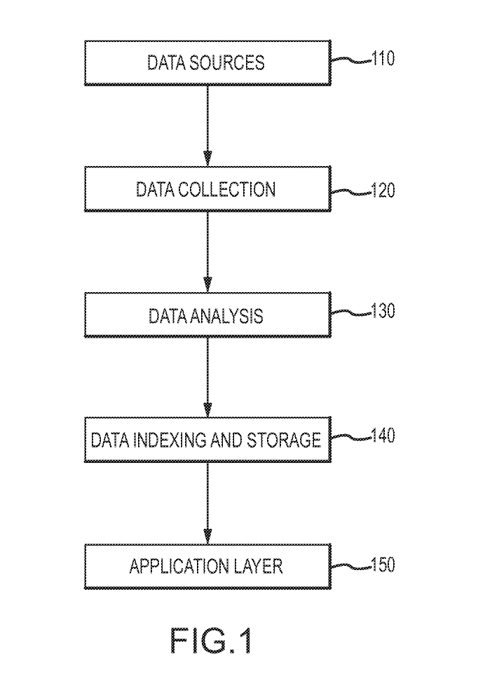

The Figures depict embodiments of the present invention for purposes of illustration only. One skilled in the art will readily recognize from the following discussion that alternative embodiments of the structures and methods illustrated herein may be employed without departing from the principles of the invention described herein.

### DESCRIPTION OF THE PRESENT INVENTION

Embodiments of the present invention are hereafter described in detail with reference to the accompanying Figures. Although the present invention has been described and illustrated with a certain degree of particularity, it is understood that the present disclosure has been made only by way of example, and that those skilled in the art can resort to numerous changes in the combination and arrangement of parts without departing from the spirit and scope of the present invention.

The following description, with reference to the accompanying drawings, is provided to assist in a comprehensive understanding of exemplary embodiments of the present invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the present invention. Also, descriptions of well-known functions and constructions are omitted for clarity and conciseness.

The terms and words used in the following description and claims are not limited to the bibliographical meanings, but are merely used by the inventor to enable a clear and consistent understanding of the present invention. Accordingly, it should be apparent to those skilled in the art that the following description of exemplary embodiments of the present invention are provided for illustration purpose only and not for the purpose of limiting the present invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the present invention. This description should be read to include one or at least one, and the singular also includes the plural unless it is obvious that it is meant otherwise.

For the purpose of the present invention, the term “sentiment” is deemed to mean the positive, negative, or neutral nature of the subject expressed by the entity providing such expression. The sentiment is a view of or attitude toward a situation or event; an opinion, a feeling, or an emotion.

Included in the description are flowcharts depicting examples of the methodology that may be used to collect and analyze topic and sentiment data. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions executed on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture. This includes instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

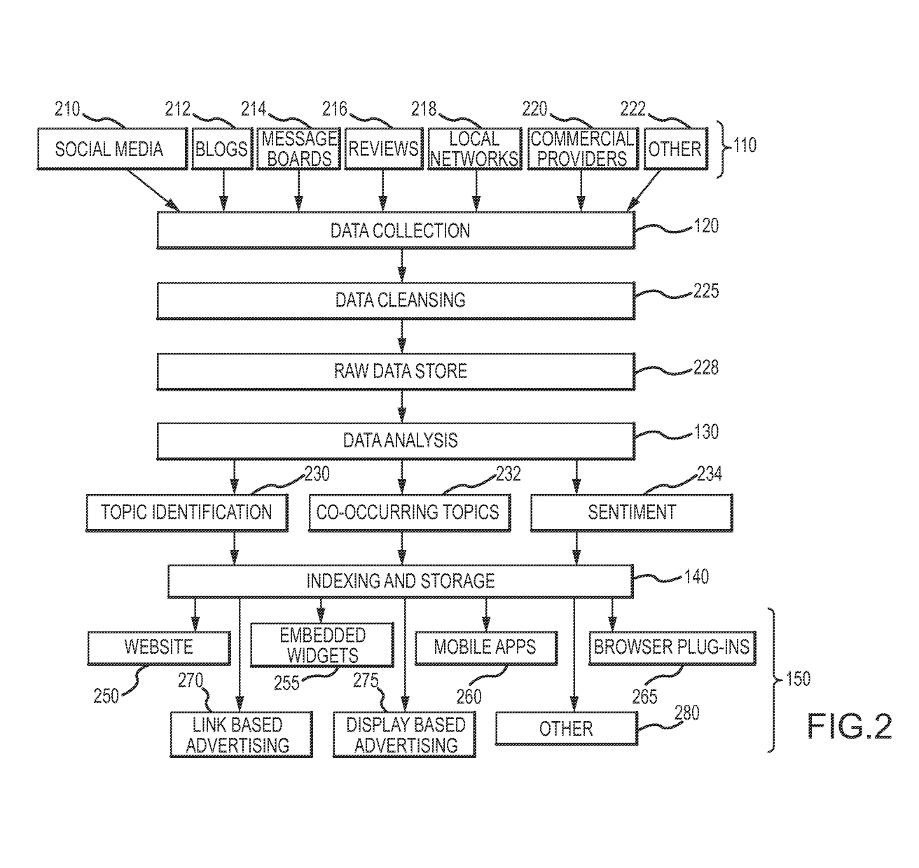

One embodiment of the present invention uses a topic-based approach to indexing and sentiment analysis as opposed to traditional, individual word-based approaches. FIG. 2 provides an overview of a system, according to the present invention, for topic and opinion analysis. As shown, data from various data sources 110 is collected 120 by the system, cleansed, and thereafter prepared for topic and sentiment analysis 130. Once analyzed, the topics are indexed and stored 140 and later retrieved 150 via an application for use/display. While most current language analysis systems use individual words to index the language, the various embodiments of the present invention use a topic-based approach, which can contain single words as well as multiple words or phrases as topics. For example, the topic “Boston” is a one-word topic. However, topics also contain multiple words. For example, “Boston Redsox” is a two-word topic, while “Staten Island Ferry” is a three-word topic.

FIG. 2 presents an expanded high-level block diagram of a system of topic identification and opinion analysis according to one embodiment of the present invention. In one version of the present invention, the system is comprised of five functional layers: The identification of data sources 110, the collection of the identified data 120, the analysis of the collected data 130, the indexing and storage of the analyzed data for use by the various applications 140, and data retrieval and use 150 by one or more applications to provide opinion information on topics of interest to users.

Data sources 110 containing public opinion data can include a variety of social media 210 and other sources of information including blogs 212, message boards 214, reviews 216, local networks 218, commercial providers 220, and other sources 222. Data from these sources 110 (collectively, the “Raw Opinion Data.”) can be collected 120 directly via crawling the individual hosts or via commercial data providers 220. Commercial data providers can include entities such as DataSift, Gnip, Spinn3r and others.

The Raw Opinion Data is collected 120 in one embodiment of the present invention via a simple text-based data collection application. Open source data collection systems exist or, one skilled in the art can easily build a unique system. Once collected, the Raw Opinion Data is cleansed 225 to, among other things, identify corrupted or incomplete records, identify the language of the post and remove posts in undesired languages, remove duplicates, and remove deceptive and untruthful posts, also known as “spam.” Once cleansed Raw Opinion Data are stored 228 in a simple database both for further processing and for archiving data for future analysis and modeling purposes.

The cleansed Raw Opinion Data is then provided to an analysis layer 130. While many analysis functions can be performed on the data, in one embodiment of the present invention, three primary analyses are performed on the data; topic identification 230, co-occurring topic identification 232, and sentiment analysis 234.

The identification of topics 230 can be accomplished in a number of ways. In one embodiment of the present invention, three approaches are used. However, it should be appreciated that additional approaches are available. The three approaches for topic identification include: (1) existing topic lists, (2) analysis of residual text, and (3) manual entry.

Topic identification 230 can be performed using a number of natural language processing and structured systems. Due to the volume of data provided to the analysis system, the system provides a rapid analysis of topics. In one embodiment of the present invention, to achieve the topic identification speed necessary to timely process the data provided, a fixed list of discussion topics is used by the topic identification system (the “Topic List.”)

To identify topics in the data from the Topic List, the analyzed text data is broken into n-grams (individual words and phrases of two, three, or more consecutive words.) Each n-gram is then compared to the Topic List and when identified, the post is tagged with the topic(s) contained therein.

It will be appreciated by one of reasonable skill in the relevant art that not all topics of discussion are contained in the Topic List. This is due to new topics being created or topics not being included in the Topic List for various reasons. As such, additional analysis may be warranted to provide a complete assessment of topics of discussion. One such analysis approach is to use natural language processing to identify topics not otherwise identified in the Topic List, and to apply statistical methods to determine the frequency of a discovered topic. Such approaches can include identification and assessment of n-grams in the remaining text not otherwise identified as topics.

### Existing Topic Lists

There are many lists of products, news or discussion articles, current events, entertainment, and other subjects online and offline. These can include, without limitation, products sold on Amazon, Wikipedia articles, subjects in Freebase, catalogues of song and album titles, trending search queries from Google and other search engines, trending topics of discussion on Twitter and other social media platforms, and tagging of articles and posts online Each source has its strengths and weaknesses. As one of the purposes of the Topic List is to identify the topics people use in discussion in expressing opinions online, user generated topic lists are often one source for these lists. For example, Wikipedia articles are created by Internet users to inform other Internet users of topics of interest. As such, the names of Wikipedia articles can provide a useful list of topics for analysis. As mentioned above, other lists can similar provide useful lists of topics.

As may be appreciated, not all topics in topic lists are useful for analysis. For example, topics with too many words or that are rarely used in discussions are of little interest. One such example is “Declaration of the Rights of Man and Citizen of 1793,” an article title on Wikipedia. Both the length of the title and its infrequent use in social media suggest that including such a topic in an index is costly and inefficient.

A rules-based or other mechanism may be employed to limit the stored topics based on the number of words in a topic, and/or its frequency in order to avoid cluttering the index with infrequently discussed topics, and to avoid wasting processing cycles and time. Analyzing infrequently used topics creates processing inefficiencies and increases costs while slowing analysis and run-time results.

### Analysis of Residual Text

Topics of interest can often be identified by analyzing text from which no topic has been found when compared to the topic list. Such text, where no matching topic is found, is called “residual text,” and running standard textual analysis of this text may uncover additional topics for consideration to be added to the Topic List.

While several approaches can be utilized to identify topics in the residual text, one such approach uses n-grams to identify a topic of n-words long where the starting point for the ‘n’ can be arbitrarily determined. For example, starting with an ‘n’ of four, the analysis will identify words one through four of the residual text as a candidate topic. Then, it will identify words two through five, then three through six, etc. Once the residual text has been analyzed for all four-word topic candidates, the process is repeated with three, two, and one-word topic candidates. The candidate topic list is then applied to the totality of the residual text to find the occurrence of each topic candidate. Topic candidates with a threshold occurrence above a set number can then either be added to the Topic List or be viewed by a human for relevance and added to the Topic List or discarded.

### Manual Entry of Topics

Topics can also be manually entered into the Topic List in the event that the use of existing topic lists and analysis of residual text does not identify all topics of interest. It is anticipated that manually entering new topics will be most useful when brand new topics of discussion surface for which no topic previously exists.

It should be appreciated that existing topic lists are updated frequently, and as such, the majority of the time the topic list approach will contain topics of discussion newly added to the public discourse. For example, while a new movie or song title may be a new and unique topic, the movie or recording studio promoting that movie or song will likely add an article to Wikipedia on the title long before the movie or song is released or discussed in the public domain. In another example, new topics of discussion on new issues of discussion will likely also be the subject of searches in search engines and/or discussed in social media. As such, these new topics may appear in trending queries or discussions in search engines and social media platforms.

### Topic Reuse

It should be appreciated by one of reasonable skill in the relevant art that a single topic may have applicability in more than one circumstance. For example, Wikipedia lists at least four articles for the search term “empty chair.” These include the title of a detective novel, a technique for Gestalt therapy, a political crisis, and a legal term. The topic “empty chair” may appear in a topic list once it is available to identify, but a different meaning or intent may exist in all four of the above examples, and new additional uses may also arise. For example, in the 2012 Republican Presidential National Convention, Clint Eastwood gave a speech to an empty chair as if speaking to then President Barack Obama. In this setting, the topic list would identify “empty chair” as a topic of discussion in connection with Clint Eastwood even though the words “empty chair” had not been previously used in that context.

### Processing of Text Using the Topic List

It is generally accepted that topics with multiple words provide more specificity with respect to the intent of the speaker than topics with fewer words. It is also important for accuracy that once a topic is identified, the words associated with that topic are removed from the available text for further topic and sentiment analysis. As such, the method used to identify topics in analyzed text is critical to provide accuracy and efficient processing.

While several approaches can be adopted, one embodiment of the present invention utilizes a decreasing number of words in the topic approach to identify topics. Through this approach, topics with the largest number of words are identified first in the analyzed text. For example, topics with four words in the topic list are compared to the analyzed text to determine if any of these topics exist in the analyzed text. If any of these topics are identified, the text is tagged as including this or these topic(s), and the words associated with this topic are removed from the analyzed text for further topic analysis. Once complete, the remaining text is searched for topics with three words, then topics with two words, and then single-word topics. At each step in the analysis, the words associated with the identified topic are removed from the analyzed text. Each topic identified is tagged as being associated with the analyzed text.

### Topics Before Sentiment

In the event that sentiment is also determined for the analyzed text, it is beneficial to first identify all topics of discussion before analyzing the text for expressions of sentiment. While all text typically contains topics, not all text contains sentiment. An example of this may be a tweet containing the following: “I am standing in line at the post office.” This text contains the two-word topic “post office” and may or may not contain the one-word topics of “standing” and “line,” but there is no expression of sentiment. However, the tweet, “I hate standing in line at the post office” obviously does contain the sentiment expression “hate” and/or “I hate.”

Since not all text contains sentiment, it is only logical to suggest that analyzed text should be processed to identify sentiment expressions first. This would help to avoid processing text that does not contain sentiment and is of no value to a system designed to assess sentiment of topics. However, sentiment words are often also used in topics. For example, Taylor Swift has recorded a song titled “Stay Beautiful.” If a system analyzes the tweet “I just bought “Stay Beautiful” on iTunes” by locating sentiment expressions first, it would likely identify and pull the word “beautiful” from the tweet, and then analyze the remainder of the tweet for topics. The only logical topic remaining in the tweet “I just bought Stay on iTunes” is “iTunes.” Under the “sentiment first” approach, the tweet would likely be tagged as a positive for iTunes due to the use of the sentiment expression “beautiful.”

In contrast, a system analyzing topics first would identify and pull the topics “Stay Beautiful” and “iTunes” from the above tweet. The remaining text “I just bought on” would likely not be identified as containing a sentiment expression and the tweet would be discarded for not containing both a topic and a sentiment expression. This is the correct result for the analysis of this tweet.

### Co-Occurring Topics

The second aspect of data analysis is co-occurring topics. A co-occurring topic 232 is a topic that occurs in close proximity to another topic such that a relationship exists between the two subject matters. An example of such a relationship between two topics is provided in the following hypothetical situation: Consider a blog post that states, “The screen on my new iPad is fantastic.” Using topic identification 230, the system will identify “screen” and “iPad” as topics in this sentence. By identifying “screen” and “iPad” as co-occurring topics 232 due to their relationship to the sentence, the user will be able to conduct deeper research into a topic of interest. For example, a user can begin a search with the topic “iPad” and then select the co-occurring topic of “screen” to assess the public opinion not just about the iPad, but also the iPad screen.

### Enhanced Co-Occurring Topic Accuracy and Relevancy

The present invention utilizes the analysis system to determine which topics are co-occurring. There are many approaches to co-occurrence, including analyzing the grammatical structure of the post, or identifying a fixed window of words in front of and behind each topic. The grammatical approach dissects the post into prepositional phrases, sentences, paragraphs, and other grammatical segments to determine which topics are contained in each segment. Those topics contained in a grammatical segment are considered co-occurring. The other approach, a purely numerical approach, ignores grammar and determines a fixed number of words before and after an identified topic and considers all topics within the defined window as co-occurring. Using a topic-based approach to processing for co-occurring topics provides a significantly more accurate, relevant, and efficient way to process text when analyzing public opinion.

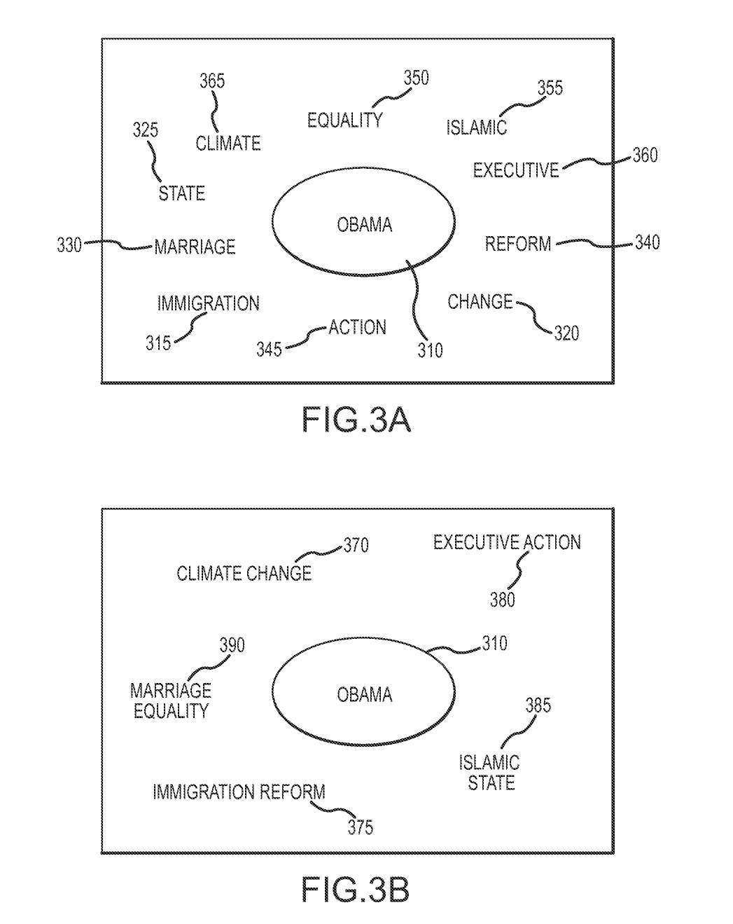

By way of comparison, traditional single-word indexing systems can surface words used in conjunction with a primary query of interest. For example, other words that may be associated with the query “Obama” 310 could include “immigration” 315, “change” 320, “state” 325, “marriage” 330, “Islamic” 335, “reform” 340, “action” 345, “equality” 350, “executive” 360, and “climate” 365. FIG. 3A represents a visual of these single words in relation to the primary query of “Obama.” These single words provide some, but limited, value to understand the interests, intent, and opinions people use in connection with the primary topic of “Obama” 310.

In a topic-based system, as provided in the current embodiment of the present invention, these same words may appear as multi-word topics, in which case the following may appear in association with the primary query of “Obama” 310: “climate change” 375, “immigration reform” 375, “executive action” 375, “Islamic State” 385, and “marriage equality” 390. FIG. 3B represents a multi-word topic approach to identifying topics discussed in connection with the primary query topic of “Obama.” It is important to note that the words in FIG. 3A and FIG. 3B are the same; however, in FIG. 3B, they are identified as multi-word topics rather than individual words.

The multi-word, topic-based approach provides significantly more relevant and accurate topics associated with the primary topic. It should also be remembered that topics in a multi-word topic approach could also be a single word. The topic “Obama” is an example of this.

In one embodiment of the present invention, a hybrid approach to topic co-occurrence is used where each post is segmented into sentences and paragraphs. When two or more topics are found within the same sentence, they are given the highest co-occurrence score. Topics that are included in the same paragraph but not the same sentence are given a lesser co-occurrence score. Finally, topics occurring in the entire post but not in the same paragraph are provided the lowest co-occurrence score. In the event that a post does not contain grammatical segments (not uncommon in social media posts), a fixed window of words behind and in front of a topic is used to determine topic co-occurrence. All topics identified as co-occurring in a post are tagged as such.

Sentiment assessment 234 is also performed on all topics identified. While there are many approaches to determine sentiment, according to one embodiment of the present invention, sentiment evaluation is performed as a straightforward, pattern-matching algorithm against the tokenized documents. A list of sentiment expressions, together with their nominal valence values (e.g. “bad: −1.0”, “great: 1.0”) is stored in a text table and loaded into memory at runtime. The nominal valence, which can range between −1.0 and 1.0, is based a combination of manual judgments and data-driven probabilities. These can be obtained using a variety of approaches including hand annotation of training datasets and analysis of existing opinion datasets, for example analysis of a large collection of product review texts, consisting of either highly-positive (5-star) or highly-negative (1-star) reviews of products and services of many categories.

The system of the present invention also pays attention to negations (e.g. “not good”) and reflects that in the final valence values. Negations are identified as patterns from a predefined, editable list.

Each topic mention is assigned a sentiment valence value, based on (1) the sentiment expression nominal valence, (2) negations (if available), and (3) the proximity (in words) of the sentiment expression to the topic mention (as a proxy of confidence that the sentiment expression applies to the given topic mention).

### Enhanced Sentiment Accuracy

As described above, topics are identified first in the subject text, removed from the text, and then sentiment is determined for the identified topics. In a multi-word topic approach, sentiment analysis is more accurate than a single word approach. This is due to several factors, including, without limitation, (1) the lack of confusion associated with the intent of the sentiment, (2) inaccuracies associated with combining sentiment for single words in multi-word topics, and (3) the potential to use topic words as sentiment words.

Multi-word topics are more precise as they provide a clearer intent of the target of the sentiment expression. For example, if a tweet said, “I hate the Boston Redsox” there is a single topic and a single expression of sentiment. In a multi-word topic approach, one embodiment of the present invention would identify one topic, “Boston Redsox,” pull that topic from the text, determine if any additional topics exist and, if not, analyze the remaining text for sentiment. In this case, the system would identify “hate” as the sentiment expression relevant to the topic “Boston Redsox.”

By comparison, in a single-word indexing approach, the same tweet would be parsed to include the two topics “Boston” and “Redsox” and one sentiment expression of “hate.” Depending on the approach taken to assess sentiment, the sentiment expression of “hate” could be applied to both the single-word topic of “Boston” and the single-word topic of “Redsox.” In this case, a sentiment search for the query “Boston” would include one negative for the single-word topic of “Boston,” thus providing an inaccurate result.

The single-word topic approach to sentiment assessment requires that sentiment for single-word topics are combined at query time for a multi-word query. Considering the prior example, if a user enters a query for sentiment on “Boston Redsox,” a single-word indexing system might combine pre-assessed sentiment for the topic “Boston” with the pre-assessed sentiment for the topic “Redsox” at query time. If the system applied negative sentiment to both the topic “Boston” and to the topic “Redsox” from the tweet “I hate the Boston Redsox,” the combination may count negatives twice with one negative for the single-word topic “Boston” and one negative for the single-word topic “Redsox.” Alternatively, if the sentiment assessment system only applied sentiment to the single topic closest to the sentiment expression, the system would offer no results from the example tweet because the system would apply the sentiment “hate” to the closest topic, “Boston,” and no sentiment for the topic “Redsox.” Combining the sentiment for “Boston” and “Redsox” at query time would not count the above tweet as there was no sentiment for “Redsox.” The system could treat the sample tweet as only expressing sentiment for “Boston.”

Further, one aspect of the present invention applies a proximity window to determine when a sentiment expression applies to an identified topic. With a single-word index, it is possible that a sentiment expression may apply to one single-word topic and not to another. In the above example, if a one-word proximity window was employed, the sentiment expression “hate” would only apply to “Boston” and would not apply to “Redsox.” As such, the results would be the same as they were if a sentiment expression could only be applied to one topic. The tweet would not be counted as an opinion on the query “Boston Redsox” since there would be no sentiment for the topic “Redsox” and the tweet could only be counted for a query for the word “Boston.”

As provided above, and in accordance with one embodiment of the present invention, the multi-word topic approach parses the sample tweet as one negative sentiment for the multi-word topic “Boston Redsox.” It does not index sentiment for either “Boston” or “Redsox” since the single-word topics of “Boston” or “Redsox” would not be identified in the sample tweet. This is because the words “Boston Redsox” would have been pulled from the tweet as a single entity (topic) before any further processing occurred.

As provided above, in one or more embodiments of the present invention, topics are identified first and removed from the analyzed text prior to the assessment of sentiment. This approach reduces the risk of treating a multi-word topic word as an expression of sentiment. For example, when analyzing the tweet, “I just bought “Stay Beautiful” on iTunes,” a single-word indexing approach may identify “stay” and “iTunes” as topics, and identify “beautiful” as the sentiment expression directed at one or both of these words. In this example, the system would register one positive for “iTunes” and possibly one positive for “stay.” However, the analysis of the tweet would be inaccurate in either case.

By way of comparison, one embodiment of the present invention would identify the multi-word topic of “Stay Beautiful” and would not identify a sentiment for this topic. It is acknowledged that the word “bought” may or may not be considered as a sentiment term by either system.

Processing Efficiencies Associated with a Multi-Word Topic Approach

In a real-time results system, indexing and determining sentiment on multi-word topics provides significant processing efficiency and, as provided above, co-topic occurrence relevancy and sentiment assessment accuracy.

As provided above, indexing on multi-word topics and storing sentiment for each such topic, enables the system to provide real-time query results with minimal processing. In one embodiment of the present invention, the system indexes on single and multi-word topics and stores the sentiment value for each in the associated database. Therefore, at query time, the system need only add the sentiment values for each shard of the database over the desired time period of the query. For example, a query containing the last ninety days of sentiment and co-occurring topics for the “Boston Redsox,” wherein the database is shard on a daily basis, the various sentiment values stored for the topic “Boston Redsox” can be simply added at run time to deliver the overall sentiment for the “Boston Redsox” as well as other topics that co-occur with the “Boston Redsox.” Simple addition at runtime requires much less processing and is much faster than a system that does not employ multi-word topics.

By comparison, for a system that indexes on single words, the query “Boston Redsox” would require the additional step of joining the stored values for “Boston” with the stored values for “Redsox” at query time in order to identify the intersection of references to “Boston” next to references of “Redsox.” This not only requires research to determine the intersection of these two single-word topics, but may also require an analysis of the original text to determine where the word “Boston” appears in reference to the word “Redsox.” Without analyzing the word location in the text, the tweet “I love Boston, but hate the Redsox” could be erroneously counted as a result in the query for “Boston Redsox.”

It will be appreciated by one of reasonable skill in the relevant art that when the subject text is analyzed, the proximity of each single-word topic to each other single-word topic can be assessed and stored along with other values identified. While this approach may obviate the need to undertake analysis of the original text at query time, it injects additional complexity into the index that would require more processing at query time. It should also be appreciated that a system could be deployed at runtime that analyzes all indexed text and assesses sentiment in real time to provide sentiment and co-occurring topic results. In such a system, single or multi-word topics could be employed to index the data. However, analyzing the text for sentiment would be performed at query time and would require far greater computing power to manage this level of analysis at query time. This is especially the case when system users enter hundreds or thousands of queries simultaneously. In addition to higher results accuracy, the current invention eliminates this additional computing resource.

Outputs from topic identification 230, topic co-occurrence 232 and sentiment 234 processes are loaded into an indexing and storage system 140. This warehouse of data analysis is thereafter queried by various applications.

To make runtime queries fast and add additional data into the indexes, the indexes are segmented by calendar days to enable certain query parameters (e.g. trending/time period) in the displayed results. However, shorter time periods may also be employed to provide processing efficiencies and/or provide additional analysis.

The indexing system 140 supports a number of applications including, without limitation, a website enabling opinion search 250, embedded results in other online or offline pages 255, mobile shopping and other apps to enable opinion information to be accessed via a mobile device 260, browser plug-ins to enable web users to view opinion information on selected content online 265, paid search and other online advertising utilizing hyperlinked text and images 270, display advertising including opinion information 275, and other applications 280.

### Website and Results Widget

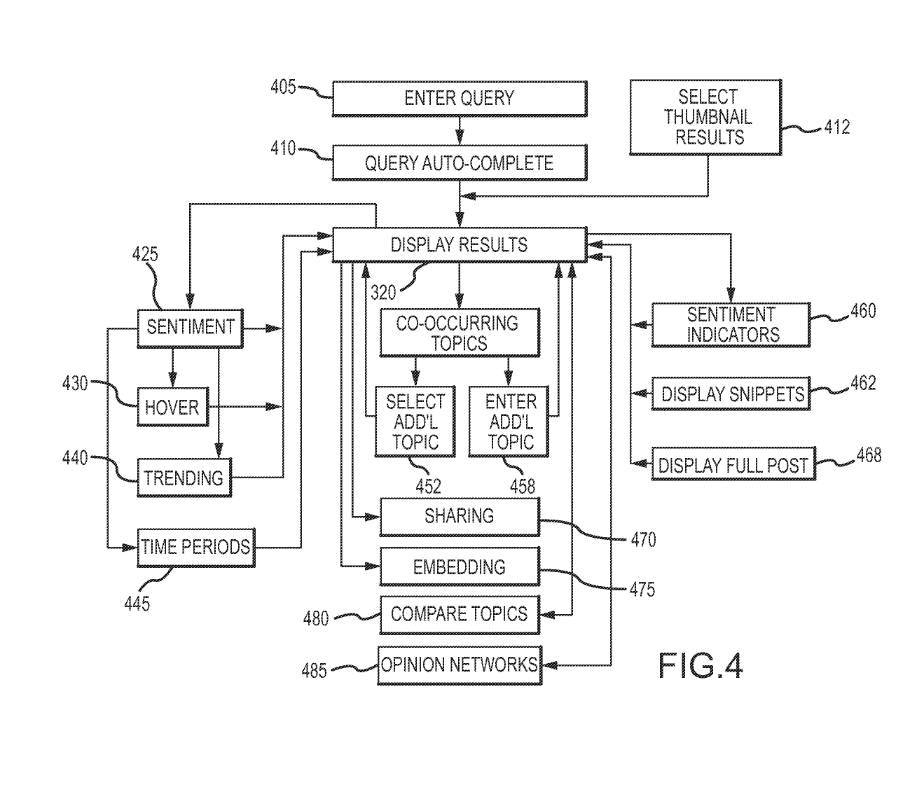

FIG. 4 illustrates a process flow diagram of a website's major function to provide opinion information, according to one embodiment of the present invention. Once a user arrives at the website, the user can either enter a query 405 or view abbreviated opinion information (thumbnails) 412 on topics determined by the popularity of queries received by the system or other methods. When the user enters a query 412, an auto-complete function 410 suggests indexed topics which the user may be typing. The ranking of the topics in the auto-complete function can be determined by a variety of rules. However, in a preferred embodiment, the rankings are determined by a combination of post frequency on the potential topics as well as historic selection of topics by previous users. The query is finalized when the user either provides the complete topic term, selects an auto-complete suggestion, or selects a thumbnail. Then, the system invokes a function call to the indexing system. This returns to a front-end system data from the indexing system for display 420, which corresponds to the selected query. For example, and as provided in greater detail below, when an end user enters the query “iPad,” the front end makes a call to the indexing system to return the aggregate sentiment scores for the topic “iPad.” The indexing system also returns the sentiment terms used to determine whether posts containing the topic iPad are positive or negative, as well as the frequency of such terms, the co-occurring topics associated with the iPad, the frequency of such topics, and sample posts containing the topic “iPad.”

While it should be appreciated that a variety of information can be displayed, in one embodiment of the present invention, the display 410 will provide a sentiment 425 for the topic, one or more co-occurring topics 450, and sentiment indicators 460.

Sentiment 425 can be displayed in a variety of ways. In one embodiment of the present invention, sentiment is provided as a percent positive and a percent negative as determined by the system and as depicted within. Data on the number of positive or negative posts can be viewed by hovering over the image 530 which depicts the percent positive or negative in the display. Sentiment data can also be viewed in a trended fashion 535 by clicking on the trend button. Thereafter, trend data will be displayed as a graph of percent positive and percent negative for various time periods. For example, trended sentiment information can be plotted using aggregate sentiment data on a daily, weekly, 10-day, and monthly basis. Aggregate sentiment information can also be viewed in different time periods of aggregation 560. For example, a user can view sentiment from the current day, the last three days, the last week, the last month, or by a selected date range chosen by the user.

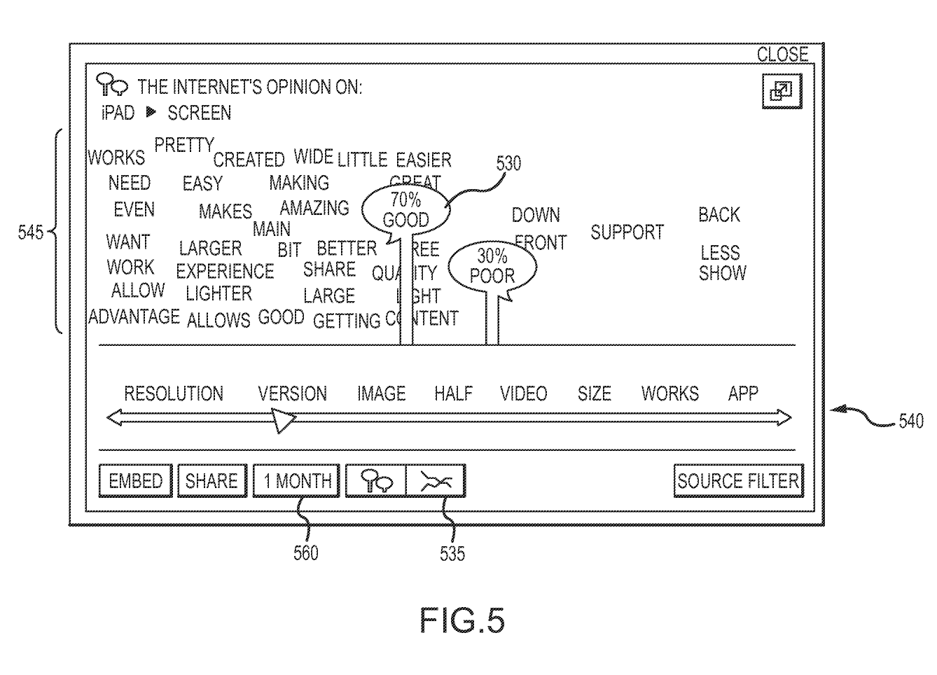

According to one embodiment of the present invention, co-occurring topic information is determined by the system and displayed as a slider of co-occurring topics 540 whereby the frequency of the co-occurrence is reflected, in one embodiment, by the font size of the co-occurring topic 545. The more frequent a topic co-occurs with the selected topic, the larger the font size. By selecting a co-occurring topic 545, the query is altered to include both the original topic and the co-occurring topic, and the combined results are displayed 530. For example, if the original topic was “iPad,” a user could select the co-occurring topic of “screen” from the list of co-occurring topics 540. Then, the Results Widget would refresh with results for the topics “iPad” and “screen” as depicted in FIG. 5. The sentiment and co-occurring topic information in the display would be determined by the intersection of the topic “iPad” and “screen” in the Indexing System. In this case, the co-occurring topics displayed would be those that co-occur with the topics “iPad” and “screen.” Co-occurring topics can also be manually entered into the system via a query bar or in the website. A co-occurring topic entered manually will deliver new results based on the intersection of the original topic and the manually entered topic in the Indexing System. For example, if the original topic was “iPad” and the user did not see the topic “battery” in the co-occurring topics presented, the user could manually enter the topic “battery” and the display would refresh with information reflecting the intersection of both terms, including the sentiment about the iPad battery.

According to one embodiment of the present invention, sentiment indicators used by those writing the social media posts are analyzed by the system for the selected topic or topics. As previously discussed, sentiment indicators are the words, phrases, symbols, and other expressions used by the system to assess sentiment. Sentiment indicators can be interpreted as adjectives, but can also include emoticons, acronyms, shorthand expressions, and other indicators of the sentiment of the writer. For example, the phrase “I <3 my new iPad” includes the shorthand expression “<3” which is used to represent a heart, and indicates that the writer loves the subject of the shorthand expression. Sentiment indicators provide the user with a measure of the strength of the emotion comprising the sentiment results and are displayed in a manner reflecting the frequency of use of each indicator. In the current embodiment of the present invention, the font size of each sentiment indicator represents the frequency of use by the authors whose posts were analyzed to provide the opinion information. Opinion intensity, or the passion expressed in the sentiment indicator, can also be represented by the color or other display means of the sentiment indicators.

Sample snippets of analyzed data that are used to form opinion information can be accessed by selecting the sentiment indicator of interest. For example, if the word “terrible” was included in the sentiment indicators associated with the query “iPad,” the user could select the word “terrible” and see snippets of social media posts including the terms “iPad” and “terrible” in algorithmic proximity. Users also have access to the full posts associated with the sample snippets provided. In one embodiment of the present invention, users can access the full post by clicking on the “read” button associated with each sample snippet.

Users can also share the results of their inquiry through a variety of means. The share function, which is common in the industry, enables a user to provide the ‘url’ to the results display and include it in a writing or other online posting. In one embodiment of the present invention, the share function is engaged by clicking on the share button on the results display from which a clipboard appears. This enables the user to copy the ‘url’ and place it in either suggested popular locations or locations selected by the user. It should be appreciated that the share function can also be invoked elsewhere in the site or the results.

The results of an inquiry can also be embedded into an online writing by invoking the embed function on the present system. It should be appreciated that the embed function can also be invoked elsewhere in the site or the results. By invoking the embed function, the fully functional results display will be placed into a writing selected by the user. It should also be appreciated that this display can be embedded in a multitude of locations on a page.

Current widgets or similar technology primarily provides view-only results. For example, Youtube widgets only enable a user to use a “play” button to begin the video clip. However, viewing an embedded display results enables the user to interact with the data presented. Moreover, each user can modify the results as if the viewer had created the original query. For example, an Internet user reading a news article can modify the displayed results to a partial or full extent as if he or she had initiated the original query. These modifications include, without limitation, the ability to click on co-occurring topics, compare topics, change the time period, trend the results, view posts, share or embed the display, and initiate a new query.

The present invention further enables users to compare the opinions of multiple topics in a single display. In the current embodiment of the present invention, once a user has initiated a query and is provided with results, he or she can click on a “compare” button and be provided with a new query bar to enter in the topic for comparison. The opinion data is displayed for both the initial topic and the compared topic. Users can add additional topics for additional comparisons. In addition to viewing the public opinion on each of the compared topics, the user can view the co-occurring topics of discussion for each of the compared topics. In one embodiment of the present invention, the co-occurring terms provided for the compared topics will be the intersection of the co-occurring topics for each of the compared topics. By way of example, consider if the compared topics were “Coke” and “Pepsi.” If “Coke” had the co-occurring topics of “can,” “commercial,” “taste,” “calories,” and “American Idol,” and Pepsi has the co-occurring topics of “can,” “calories,” “bubbles,” “taste,” “X Factor,” and “concert”, the co-occurring topics presented for the compared topics would be “can,” “calories,” and “taste.” It should also be appreciated that the present invention can display each list of co-occurring topics for each topic separately or as a combined list. A user can select a co-occurring topic from a list of co-occurring topics that is the intersection of the co-occurring topics for all compared topics. Then, the results would be updated to display data for the co-occurring topic for each of the compared topics. Similarly, the sentiment indicators for each of the compared topics would be displayed either as an intersection (one embodiment), a separate list for each compared topic, or a combination of all sentiment indicators for all compared topics. Selecting any sentiment indicator would enable to user to see either snippets or the full post.

Another aspect of the present invention is to enable a user to filter the opinions displayed by different networks of social media participants depending on the interests of the user. In one embodiment of the present invention, the Opinion Networks can include, without limitation, the following: (1) “Host Networks,” whereby the user can select to view only the opinions of people in a select social media or other network, for example, only the opinions from people posting on Facebook or Twitter; (2) “Expert Networks,” whereby the user can select to view only the opinions of people who are considered experts on the topic, for example, viewing the opinion of auto experts on the topic of the Toyota Prius; (3) “Trusted Networks,” whereby the user can select to view only the opinions from select people identified by the user, for example, only the people he or she follows on Twitter; and, (4) “Demographic Networks,” whereby the user can select only opinions from a demographic segment of interest, for example, only males who live in Iowa. It should be appreciated that additional “Opinions Networks” can be created.

For example, in a single display window, a user can compare the opinions of Facebook users to Twitter users on the topic of “immigration.” Or, he or she can compare the general population of the social media dataset to auto experts on the topic of the “Toyota Prius.”

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

It will also be understood by those familiar with the art, that the present invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the present invention or its features may have different names, divisions, and/or formats. Furthermore, as will be apparent to one of ordinary skill in the relevant art, the modules, managers, functions, systems, engines, layers, features, attributes, methodologies, and other aspects of the present invention can be implemented as software, hardware, firmware, or any combination of the three. Of course, wherever a component of the present invention is implemented as software, the component can be implemented as a script, as a stand-alone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

In a preferred embodiment, the present invention can be implemented in software. Software programming code that embodies the present invention is typically accessed by a microprocessor from long-term, persistent storage media of some type, such as a flash drive or hard drive. The software programming code may be embodied on any of a variety of known media for use with a data processing system, such as a diskette, hard drive, CD-ROM, or the like. The code may be distributed on such media, or may be distributed from the memory or storage of one computer system over a network of some type to other computer systems for use by such other systems. Alternatively, the programming code may be embodied in the memory of the device and accessed by a microprocessor using an internal bus. The techniques and methods for embodying software programming code in memory, on physical media, and/or distributing software code via networks are well known and will not be further discussed herein.

Generally, program modules include routines, programs, objects, components, data structures and the like that perform particular tasks or implement particular abstract data types. Moreover, those skilled in the art will appreciate that the present invention can be practiced with other computer system configurations, including hand-held devices, multi-processor systems, microprocessor-based or programmable consumer electronics, network PCs, minicomputers, mainframe computers, and the like. The present invention may also be practiced in distributed computing environments where tasks are performed by remote processing devices that are linked through a communications network. In a distributed computing environment, program modules may be located in both local and remote memory storage devices.

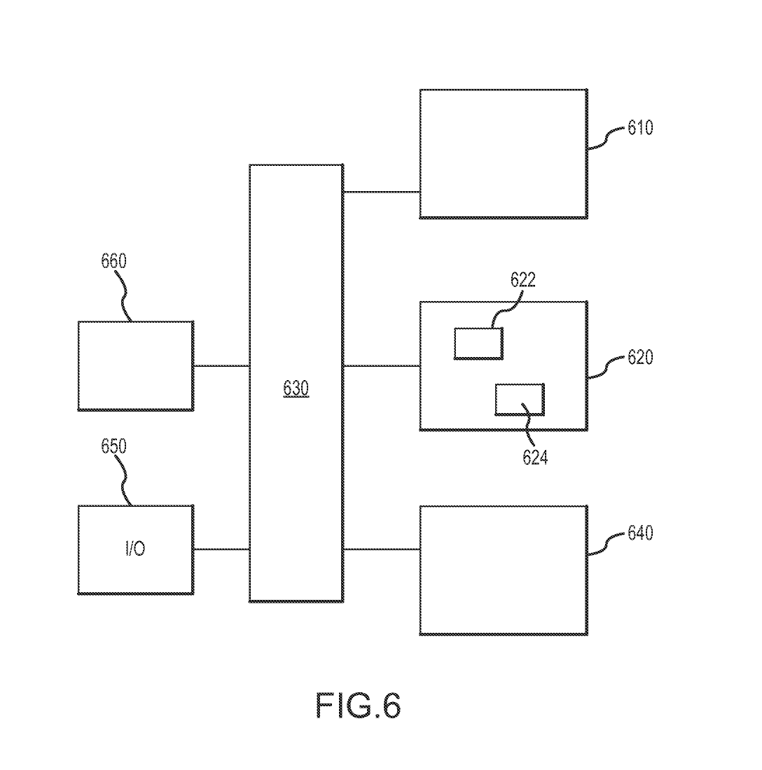

An exemplary system for implementing the present invention as shown in FIG. 6 includes a general purpose computing device such as the form of a conventional personal computer, a personal communication device or the like, including a processing unit 610, a system memory 620, and a system bus 630 that couples various system components, including the system memory 620 to the processing unit 610. The system bus may be any of several types of bus structures including a memory bus or memory controller, a peripheral bus, and a local bus using any of a variety of bus architectures. The system memory generally includes read-only memory (ROM) 622 and random access memory (RAM) 624. A basic input/output system (BIOS), containing the basic routines that help to transfer information between elements within the personal computer, such as during start-up, is stored in ROM. The personal computer may further include a hard disk drive 640 for reading from and writing to a hard disk, and a magnetic disk drive for reading from or writing to a removable magnetic disk. The hard disk drive and magnetic disk drive are connected to the system bus by a hard disk drive interface and a magnetic disk drive interface, respectively. The drives and their associated computer-readable media provide non-volatile storage of computer readable instructions, data structures, program modules and other data for the personal computer. Further connected to the system bus 630 are input/output (I/O) devices and communication devices and network access capabilities 640.

Although the exemplary environment described herein employs a hard disk and a removable magnetic disk, it should be appreciated by those skilled in the art that other types of computer readable media which can store data that is accessible by a computer may also be used in the exemplary operating environment.

Embodiments of the present invention as have been herein described may be implemented with reference to various wireless networks and their associated communication devices. Networks can also include mainframe computers or servers, such as a gateway computer or application server (which may access a data repository). A gateway computer or device serves as a point of entry into each network. The gateway may be coupled to another network by means of a communications link. The gateway may also be directly coupled to one or more devices using a communications link. Further, the gateway may be indirectly coupled to one or more devices. The gateway computer may also be coupled to a storage device such as data repository.

One or more implementations of the present invention may occur in a Web environment, where software installation packages are downloaded using a protocol such as the HyperText Transfer Protocol (HTTP) from a Web server to one or more target computers (devices, objects) that are connected through the Internet. Alternatively, an implementation of the present invention may be executing in other non-Web networking environments (using the Internet, a corporate intranet or extranet, or any other network) where software packages are distributed for installation using techniques as would be known to one of reasonable skill in the relevant art. Configurations for the environment include a client/server network, as well as a multi-tier environment. Furthermore, it may happen that the client and server of a particular installation both reside in the same physical device, in which case a network connection is not required.

As will be understood by those familiar with the art, the present invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the present invention or its features may have different names, divisions, and/or formats. Furthermore, as will be apparent to one of ordinary skill in the relevant art, the modules, managers, functions, systems, engines, layers, features, attributes, methodologies, and other aspects of the present invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

We claim:

1. A computer-implemented method for analysis of accessible data, the method comprising:
performing by at least one processor,
identifying a plurality of topics of interests wherein each topic of interest is characterized by a plurality of words,
detecting content from accessible data by matching each topic of interest within text of the accessible data,
analyzing accessible data for words indicating a sentiment, and
responsive to the detected content including words indicating sentiment determining whether the sentiment is positive or negative;
entering into an indexing and storage media, each topic of interest and the sentiment forming a corpus of sentiment data.

2. The computer-implemented method for analysis of accessible data according to claim 1, wherein identifying includes selecting each topic of interest from a preexisting topic of interest list.

3. The computer-implemented method for analysis of accessible data according to claim 1, wherein identifying includes analysis of residual text to determine each topic of interest.

4. The computer-implemented method for analysis of accessible data according to claim 1, wherein identifying includes manual entry of each topic of interest.

5. The computer-implemented method for analysis of accessible data according to claim 1, further comprising determining whether detected content includes one or more co-occurring topics of interest wherein a co-occurring topic of interest is an additional topic of interest within a predefined proximity of each topic of interest forming a relationship between each topic of interest and the co-occurring topic of interest.

6. The computer-implemented method for analysis of accessible data according to claim 5, wherein the co-occurring topic of interest is a multi-word topic of interest.

7. The computer-implemented method for analysis of accessible data according to claim 1, wherein matching includes a decreasing word matching process whereby matching first occurs for an entirety of the plurality of words of each topic of interest and thereafter decreases the plurality of words of each topic of interest by one word until each topic of interest is a single word.

8. The computer-implemented method for analysis of accessible data according to claim 1, wherein responsive to the detected content including words indicating sentiment associating a sentiment value to each topic of interest.

9. The computer-implemented method for analysis of accessible data according to claim 8, further comprising initiating a runtime query to ascertain the sentiment associated with a specific topic of interest over a period of time wherein the runtime query aggregates sentiment values in the corpus of sentiment data for the specific topic of interest over the period of time and provides a list of co-occurring topics of interest.

10. The computer-implemented method for analysis of accessible data according to claim 1, further comprising accessing the corpus of sentiment data to ascertain sentiment information regarding a chosen topic of interest.

11. The computer-implemented method for analysis of accessible data according to claim 1, wherein analyzing accessible data for words indicating sentiment occurs subsequent to matching each topic of interest with text of accessible data.

12. A system for analysis of accessible data, the system comprising:
at least one processor;
a storage medium;
at least one program stored in the storage medium and executable by the at least one processor, the at least one program comprising instructions to:
identify a plurality of topics of interests wherein each topic of interest is characterized by a plurality of words,
detect content from accessible data by matching each topic of interest within text of the accessible data,
analyze accessible data for words indicating a sentiment,
responsive to the detected content including words indicating sentiment, determine whether the sentiment is positive or negative, and
enter into an indexing and a storage media, each topic of interest and the sentiment forming a corpus of sentiment data.

13. The system for analysis of accessible data according to claim 12 wherein each topic of interest is chosen from a preexisting topic of interest list.

14. The system for analysis of accessible data according to claim 12, wherein each topic of interest is identified by analysis of residual text.

15. The system for analysis of accessible data according to claim 12, wherein the at least one program comprising instructions determines whether detected content includes one or more co-occurring topics of interest and wherein a co-occurring topic of interest is an additional topic of interest within a predefined proximity of each topic of interest forming a relationship between each topic of interest and the co-occurring topic of interest.

16. The system for analysis of accessible data according to claim 12, wherein matching includes a decreasing word matching process whereby matching first occurs for an entirety of the plurality of words of each topic of interest and thereafter decreases the plurality of words of each topic of interest by one word until each topic of interest is a single word.

17. The system for analysis of accessible data according to claim 12, wherein responsive to the detected content including words indicating sentiment each topic of interest is associated with a sentiment value.

18. The system for analysis of accessible data according to claim 12, wherein analysis of accessible data for words indicating sentiment occurs subsequent to matching each topic of interest with text of accessible data.

19. A non-transitory computer readable storage medium storing at least one program configured for execution by a computer, the at least one program comprising instructions to:
identify a plurality of topics of interests wherein each topic of interest is characterized by a plurality of words,
detect content from accessible data by matching each topic of interest within text of the accessible data,
analyze accessible data for words indicating a sentiment,
responsive to the detected content including words indicating sentiment, determine whether the sentiment is positive or negative, and
enter into an indexing and a storage media, each topic of interest and the sentiment forming a corpus of sentiment data.

20. The non-transitory computer readable storage medium of claim 17 wherein the at least one program further comprises instructions to determine whether detected content includes one or more co-occurring topics of interest and wherein a co-occurring topic of interest is an additional topic of interest within a predefined proximity of each topic of interest forming a relationship between each topic of interest and the co-occurring topic of interest.

21. The non-transitory computer readable storage medium of claim 17 wherein matching includes a decreasing word matching process whereby matching first occurs for an entirety of the plurality of words of each topic of interest and thereafter decreases the plurality of words of each topic of interest by one word until each topic of interest is a single word.

22. The non-transitory computer readable storage medium of claim 17, wherein responsive to the detected content including words indicating sentiment associating a sentiment value to each topic of interest.

23. The non-transitory computer readable storage medium of claim 17, wherein the analysis of accessible data for words indicative of sentiment follows matching each topic of interest with text of the accessible data.
